(19) United States
(12) Patent Application Publication
(10) Pub. No.: US 2009/0070615 A1
(43) Pub. Date: Mar. 12, 2009

(54) Multiple power supply management scheme in a power over ethernet (POE) system

(75) Inventors: Louis Joseph Maggiolino, Cupertino, CA (US); Yossi Shanava, Santa Clara, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporaion, Irvine (CA)

(21) Appl. No.: 11/976,999

(22) Filed: Oct. 30, 2007

Related U.S. Application Data
(60) Provisional application No. 60/960,003, filed on Sep. 11, 2007.

(51) Int. Cl. G06F 1/26; G06F 13/24

(52) U.S. Cl. 713/340; 710/267; 713/300

(57) ABSTRACT

An apparatus and method is disclosed to manage multiple power supplies in a Power over Ethernet (PoE) communication system. The PoE communication system provides PoE to one or more powered devices (PDs) using one or more DC voltage supplies. The PoE communication system includes a power source equipment (PSE) controller that monitors the one or more DC voltage supplies based on the dynamic needs of one or more PDs using power status indicators received via a power bank data interface. The PSE controller includes a multiple power supply management (MPSM) module to receive the power status indicators via the power bank data interface. The MPSM module compares the values of received power status indicators with default or stored power status indicators. When the value of received power status indicators differ from the stored power status indicators, the MPSM module communicates a power down signal to a port controller via a port controller interface and/or an interrupt signal to a microcontroller via a shared communication interface. The power down signal allows the port controller to rapidly remove power from one or more data ports in the PoE system in response to the alteration in the amount of power available for PoE. The interrupt signal allows the microcontroller to respond to the alteration in the amount of power available for PoE.

### CROSS-REFERENCE TO RELATED APPLICATIONS

This patent application claims the benefit of Provisional Patent Application No. 60/960,003, filed Sep. 11, 2007, entitled “Multiple Power Supply Management Scheme in a Power Over Ethernet (POE) System,” which is incorporated herein by reference in its entirety.

### BACKGROUND OF THE INVENTION

1. Field of the Invention

The present invention generally relates to a power management scheme in a Power over Ethernet (PoE) system, and more specifically to a multiple power supply management scheme.

2. Related Art

Ethernet communications provide high speed data communications over a communications link between two communication nodes that operate according to the IEEE 802 Ethernet Standard. The communications medium between the two nodes can be twisted pair wires for Ethernet, or other types of communications medium that are appropriate. Power over Ethernet (PoE) communication systems provide power and data communications over a common communications link. More specifically, a power source device (e.g., power source equipment (PSE)) connected to the physical layer of the first node of the communications link provides DC power (for example, 48 volts DC) to a powered device (PD) at the second node of the communications link. The DC power is transmitted simultaneously over the same communications medium with the high speed data from one node to the other node.

The power source device provides DC power using one or more DC voltage supplies. Changes in the one or more DC voltage supplies may directly effect the amount of DC power available for PoE. For example, the amount of power available for PoE may decrease as a result of a failure of one or more DC voltage supplies or the amount of power available for PoE may increase as a result adding one or more DC voltage supplies to the PoE communication system. Conventional systems manage the DC voltage supplies using various approaches that are very customer specific, and require different versions of the silicon to support variation in the PoE communication system's power supply scheme. Therefore, what is needed is a multiple power supply management scheme that addresses the issues of managing one or more DC voltage supplies in the PoE communication system.

### BRIEF DESCRIPTION OF THE DRAWINGS/FIGURES

FIG. 1 is a block diagram of a Power over Ethernet (PoE) system according to an exemplary embodiment of the present invention.

FIG. 2 illustrates a more detailed figure of the power transfer from Power source equipment (PSE) to a Powered Device (PD) in a PoE communications system according to an exemplary embodiment of the present invention.

FIG. 3 is a block diagram of a direct current (DC) power supply used in the Power over Ethernet (PoE) system according to an exemplary embodiment of the present invention.

FIG. 4 is a more detailed figure of the power source equipment (PSE) controller in a PoE communications system according to an exemplary embodiment of the present invention.

FIG. 5A is a block diagram of a multiple power supply management (MPSM) module according to an exemplary embodiment of the present invention.

FIG. 5B is a block diagram of a low power priority (LPP) register bank according to an exemplary embodiment of the present invention.

FIG. 6 is a block diagram of a multiple power supply management (MPSM) module according to another exemplary embodiment of the present invention.

FIG. 7 is a flowchart of exemplary operational steps of a multiple power supply management (MPSM) module according to another exemplary embodiment of the present invention.

The present invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

The following detailed description of the present invention refers to the accompanying drawings that illustrate exemplary embodiments consistent with this invention. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Other embodiments are possible, and modifications may be made to the embodiments within the spirit and scope of the invention. Therefore, the detailed description is not meant to limit the invention. Rather, the scope of the invention is defined by the appended claims.

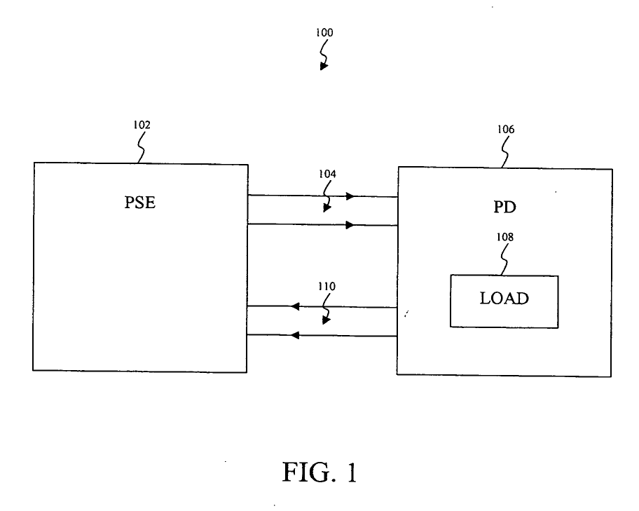

FIG. 1 is a block diagram of a Power over Ethernet (PoE) system according to an exemplary embodiment of the present invention. More specifically, FIG. 1 illustrates a high level diagram of a Power over Ethernet (PoE) system 100 that provides both DC power and data communications over a common data communications medium. Referring to FIG. 1, the power source equipment (PSE) 102 provides DC power over conductors 104, 110 to a powered device (PD) 106 having a representative electrical load 108. Although FIG. 1 shows a single PD, namely PD 106, connected to the PSE 102, those skilled in the art will recognize that multiple PDs may be connected to the PSE 102 with departing from the spirit and scope of the invention. The PSE 102 provides PoE according to a known PoE standard, such as the IEEE 802.3af™ standard, the IEEE 802.3at™ standard, the IEEE 802.3™ standard, a legacy PoE transmission, and/or any suitable type of PoE transmission standard to provide some examples. The PSE 102 and PD 106 also include data transceivers that operate according to a known communications standard, such as a 10BASE-T, a 100BASE-TX, a 1000BASE-T, a 10GBASE-T, and/or any other suitable communication standard to provide some examples. More specifically, the PSE 102 includes a physical layer device on the PSE side that transmits and receives high speed data to and from a corresponding physical layer device in the PD 106, as will be discussed further below. Accordingly, the power transfer between the PSE 102 and the PD 106 occurs simultaneously with the exchange of high speed data over the conductors 104, 110. In one example, the PSE 102 is a data switch having multiple ports that is in communication with one or more PD devices, such as Internet phones, or a wireless access point.

The conductor pairs 104 and 110 can carry high speed differential data communications. In one example, the conductor pairs 104 and 110 each include one or more twisted wire pairs, or any other type of cable or communications media capable of carrying the data transmissions and DC power transmissions between the PSE and PD. In Ethernet communications, the conductor pairs 104 and 110 can include multiple twisted pairs, for example four twisted pairs for 10 Gigabit Ethernet. In 10/100 Ethernet, only two of the four pairs carry data communications, and the other two pairs of conductors are unused. Herein, conductor pairs may be referred to as Ethernet cables or communication links for ease of discussion.

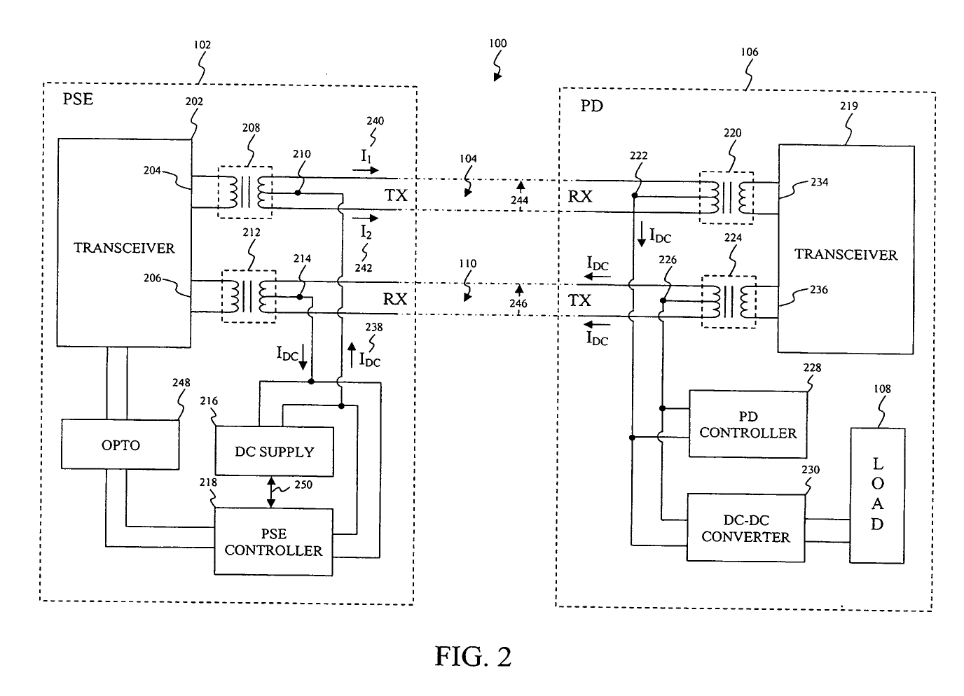

FIG. 2 illustrates a more detailed figure of the power transfer from Power source equipment (PSE) to a Powered Device (PD) in a PoE communications system according to an exemplary embodiment of the present invention. More specifically, FIG. 2 provides a more detailed circuit diagram of the PoE system 100, where the PSE 102 provides power for PoE to PD 106 over conductor pairs 104 and 110. The PSE 102 includes a transceiver physical layer device (or PHY) 202 having full duplex transmit and receive capability through differential transmit port 204 and differential receive port 206. (Herein, transceivers may be referred to as PHYs) A first transformer 208 couples high speed data between the transmit port 204 and the first conductor pair 104. Likewise, a second transformer 212 couples high speed data between the receive port 206 and the second conductor pair 110. The respective transformers 208 and 212 pass the high speed data to and from the transceiver 202, but isolate any low frequency or DC voltage from the transceiver ports, which may be sensitive large voltage values.

The first transformer 208 includes primary and secondary windings, where the secondary winding (on the conductor side) includes a center tap 210. Likewise, the second transformer 212 includes primary and secondary windings, where the secondary winding (on the conductor side) includes a center tap 214. The DC voltage supply 216 generates an output voltage that is applied across the respective center taps of the transformers 208 and 210 on the conductor side of the transformers. The center tap 210 is connected to a first output of a DC voltage supply 216, and the center tap 214 is connected to a second output of the DC voltage supply 216. As such, the transformers 208 and 212 isolate the DC voltage from the DC supply 216 from the sensitive data ports 204, 206 of the transceiver 202. An example DC output voltage is 48 volts, but other voltages could be used depending on the voltage/power requirements of the PD 106.

The PSE 102 further includes a PSE controller 218 that monitors the DC voltage supply 216 based on the dynamic needs of the PD 106 via a power bank data interface 250. The power bank data interface 250 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The power bank data interface 250 may be implemented as a serial data bus, a parallel data bus, one or more point-to-point connections, one or more point-to-multipoint connections, or any other suitable connection capable of communicating data.

The PSE controller 218 measures the voltage, current, and temperature of the outgoing and incoming DC supply lines so as to characterize the power requirements of the PD 106. Further, the PSE controller 218 detects and validates a compatible PD, determines a power classification signature for the validated PD, supplies power to the PD, monitors the power, and reduces or removes the power from the PD when the power is no longer requested or required. During detection, if the PSE finds the PD to be non-compatible, the PSE can prevent the application of power to that PD device, protecting the PD from possible damage. IEEE has imposed standards on the detection, power classification, and monitoring of a PD by a PSE in the IEEE 802.3af™ standard and the IEEE 802.3™ standard, both of which are incorporated herein by reference.

Still referring to FIG. 2, the contents and functionality of the PD 106 will now be discussed. The PD 106 includes a transceiver physical layer device 219 having full duplex transmit and receive capability through differential transmit port 236 and differential receive port 234. A third transformer 220 couples high speed data between the first conductor pair 104 and the receive port 234. Likewise, a fourth transformer 224 couples high speed data between the transmit port 236 and the second conductor pair 110. The respective transformers 220 and 224 pass the high speed data to and from the transceiver 219, but isolate any low frequency or DC voltage from the sensitive transceiver data ports.

The third transformer 220 includes primary and secondary windings, where the secondary winding (on the conductor side) includes a center tap 222. Likewise, the fourth transformer 224 includes primary and secondary windings, where the secondary winding (on the conductor side) includes a center tap 226. The center taps 222 and 226 supply the DC power carried over conductors 104 and 110 to the representative load 108 of the PD 106, where the load 108 represents the dynamic power draw needed to operate PD 106. A DC-DC converter 230 may be optionally inserted before the load 108 to step down the voltage as necessary to meet the voltage requirements of the PD 106. Further, multiple DC-DC converters 230 may be arrayed in parallel to output multiple different voltages (3 volts, 5 volts, 12 volts) to supply different loads 108 of the PD 106.

The PD 106 further includes a PD controller 228 that monitors the voltage and current on the PD side of the PoE configuration. The PD controller 228 further provides the necessary impedance signatures on the return conductor 110 during initialization, so that the PSE controller 218 will recognize the PD as a valid PoE device, and be able to classify its power requirements.

During ideal operation, a direct current (I_{DC}) 238 flows from the DC power supply 216 through the first center tap 210, and divides into a first current (I₁) 240 and a second current (I₂) 242 that is carried over conductor pair 104. The first current (I₁) 240 and the second current (I₂) 242 then recombine at the third center tap 222 to reform the direct current (I_{DC}) 238 so as to power PD 106. On return, the direct current (I_{DC}) 238 flows from PD 106 through the fourth center tap 226, and divides for transport over conductor pair 110. The return DC current recombines at the second center tap 214, and returns to the DC power supply 216. As discussed above, data transmission between the PSE 102 and the PD 106 occurs simultaneously with the DC power supply described above. Accordingly, a first communication signal 244 and/or a second communication signal 246 are simultaneously differentially carried via the conductor pairs 104 and 110 between the PSE 102 and the PD 106. It is important to note that the communication signals 244 and 246 are differential signals that ideally are not effected by the DC power transfer.

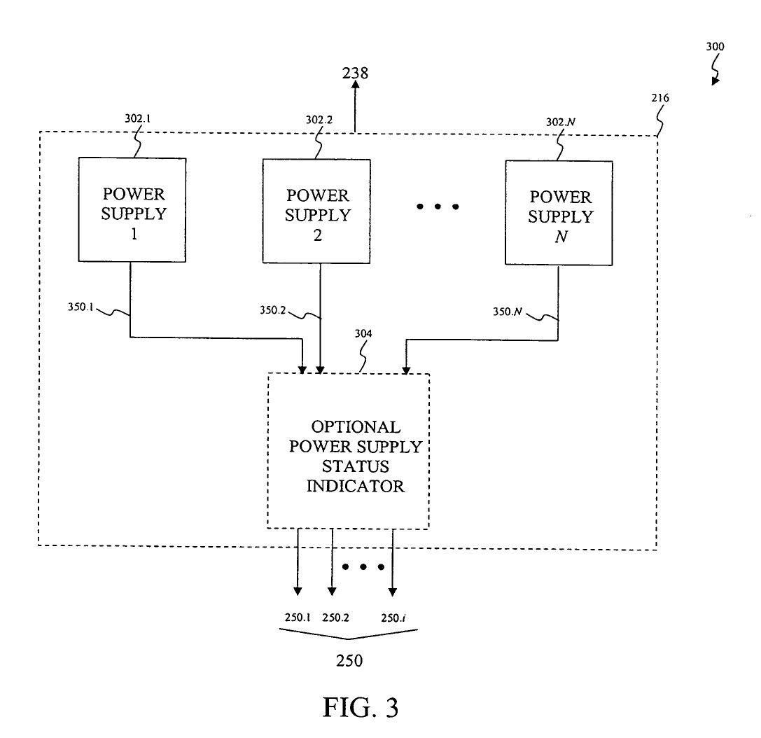

FIG. 3 is a block diagram of a direct current (DC) power supply used in the Power over Ethernet (PoE) system according to an exemplary embodiment of the present invention. As shown in FIG. 3, the DC voltage supply 216 includes, but is not limited to, a DC voltage supply 302 and an optional power status indicator generator 304.

The DC voltage supply 302 may include, but is not limited to, a single DC voltage supply, such as the DC voltage supply 302.1 or multiple DC voltage supplies, such as the DC voltage supplies 302.1 through 302.N. Each power supply of the DC voltage supplies 302.1 through 302.N may be implemented as, but is not limited to, an AC/DC power supply, a DC/DC power supply or any other power generating device capable of outputting a DC voltage. The PSE controller 218 may control the DC voltage supplies 302.1 through 302.N individually or as a group based on the dynamic needs of the PD 106.

Referring back to FIG. 3, the DC voltage supplies 302.1 through 302.N generate a corresponding power status indicator 350.1 through 350.N. The power status indicators 350.1 through 350.N may indicate, but are not limited to, the total amount of the power available for PoE, the amount of the power that is currently used for PoE, the amount of the power that is remaining to be used for PoE, or any other suitable indication of the power status related to the DC power to provide some examples. The DC voltage supplies 302.1 through 302.N may generate the corresponding power status indicators 350.1 through 350.N continuously, at regular intervals, upon request, or any other suitable interval to provide some examples. Each one of the power status indicators 350.1 through 350.N may be, but is not limited to a single bit, one or more bits, a single byte, one or more bytes, any combination of bits or bytes, or any other suitable data length. Those skilled in the arts will recognize that the power status indicators 350.1 through 350.N may be of any length without departing from the spirit and scope of the invention. The power status indicators 350.1 through 350.N may be readily generated in hardware, software, or a combination of hardware and software. For example, based on the teachings provided herein, a person skilled in the relevant art could generate the power status indicators 350.1 through 350.N via a combination of one or more application specific integrated circuits and a processor core for implementing software commands stored in one or more attached memories. However, this example is not limiting, and other implementations are within the scope and spirit of the present invention.

The optional power status indicator generator 304 outputs an encoded representation of the power status indicators 350.1 through 350.N via the power bank data interface 250. In particular, the optional power status indicator generator 304 encodes the power status indicators 350.1 through 350.N onto i power bank data connections 250.1 through 250.i using known encoding techniques that are capable of transforming the power status indicators 350.1 through 350.N. For example, a DC voltage supply 216 including eight power supplies 302.1 through 302.8 may efficiently communicate the power status indicators 350.1 through 350.N to the PSE controller 218 using the power bank data connections 250.1 through 250.3. In those embodiments that do not implement the DC voltage supply 216 to include the optional power status indicator generator 304, the DC voltage supplies 302.1 through 302.N may directly communicate the power status indicators 350.1 through 350.N to the PSE controller 218 using the power bank data connections 250.1 through 250.i.

The optional power status indicator generator 304 may be readily implemented in hardware, software or a combination of hardware and software. For example, based on the teachings provided herein, a person skilled in the relevant art could implement the optional power status indicator generator 304 via a combination of one or more application specific integrated circuits and a processor core for implementing software commands stored in one or more attached memories. However, this example is not limiting, and other implementations are within the scope and spirit of the present invention.

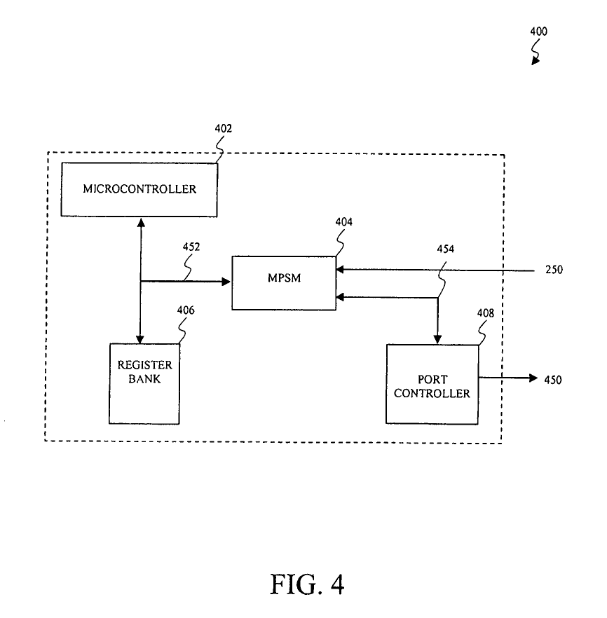

FIG. 4 is an illustration of a more detailed figure of the power source equipment (PSE) controller in a PoE communications system according to an exemplary embodiment of the present invention. The main functions of the PSE controller 218 are to search for a PD, optionally classify the PD, supply power (only if a PD is detected), monitor the power, and scale power back when power is longer requested or required. These exemplary functionalities are for illustrative purposes only; additional functionality may be implemented which will be apparent to those skilled in the arts. The PSE controller 218 includes, but is not limited to, a microcontroller 402, a multiple power supply management (MPSM) module 404, a register bank 406, and a port controller 408. Those skilled in the arts will recognize that the PSE controller 218 may contain additional functional modules without departing from the spirit and scope of the invention.

The microcontroller 402 communicates information with the other modules in the PSE controller 218 via a shared communication interface 452. The shared communication interface 452 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The shared communication interface 452 may be implemented as a serial data bus, a parallel data bus, one or more point-to-point connections, one or more point-to-multipoint connections, or any other suitable connection capable of communicating data.

The microcontroller 402 may be implemented as a microprocessor including an arithmetic logic unit (ALU), a control unit, and general purpose registers or a microcontroller that additionally includes memory storage elements such as a Read Only Memory (ROM) or a Random Access Memory (RAM) to provide some examples. The microcontroller 402 may provide, but is not limited to, the following exemplary features to the PSE controller 218: a central processing unit (CPU)—ranging from 4-bit processors to 64-bit processors, input/output interfaces such as a universal asynchronous receiver/transmitter (UART), other communications interfaces such as an Inter-Integrated Circuit (I²C) network interface, Serial Peripheral Interface and Controller Area Network for system interconnect, peripherals such as timers or watchdog capabilities, RAM for data storage, ROM, EPROM, EEPROM or Flash memory for program storage, a clock generator, analog-to-digital converters, or any other suitable feature which will apparent to those skilled in the arts. These exemplary functionalities are for illustrative purposes only; additional functionality may be implemented, which will be apparent to those skilled in the arts. In an exemplary embodiment, the microcontroller 402 is implemented as an 8-bit microcontroller.

The microcontroller 402 includes an interrupt-driven microprocessor that may respond to a hardware interrupt, a software interrupt and/or a combination of a hardware and software interrupt. A hardware interrupt causes the microcontroller 402 to save its state of execution via a context switch, and begin execution of an interrupt handler. Software interrupts are usually implemented as instructions in the instruction set, which cause a context switch to an interrupt handler similarly to a hardware interrupt. The microcontroller 402 may respond to a level-triggered interrupt, an edge-triggered interrupt, a message-signaled interrupt, and/or any other suitable class of interrupts individually or in combination.

Referring back to FIG. 4, the MPSM module 404 receives the power status indicators 350.1 through 350.N via the power bank data interface 250. The MPSM module 404 compares the values of received power status indicators 350.1 through 350.N with default or stored power status indicators 350.1 through 350.N. The stored power status indicators 350.1 through 350.N may be previously received power status indicators, power status indicators programmed by an external source, or any other suitable prior power status indicator that may be compared to the received power status indicators 350.1 through 350.N. When the value of received power status indicators 350.1 through 350.N differ from the stored power status indicators 350.1 through 350.N, the MPSM module 404 communicates a power down signal to the port controller 410 via a port controller interface 454 and/or an interrupt signal to the microcontroller 402 via the shared communication interface 452. The port controller interface 454 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The port controller interface 454 may be implemented as a serial data bus, a parallel data bus, one or more point-to-point connections, one or more point-to-multipoint connections, or any other suitable connection capable of communicating data.

A difference between the stored power status indicators 350.1 through 350.N and the received power status indicators 350.1 through 350.N represents an alteration in an amount of power available for PoE. For example, the amount of power available for PoE may decrease as a result of a failure of one or more DC voltage supplies 302.1 through 302.N to the DC voltage supply 216, an addition of one or more DC voltage supplies 302.1 through 302.N to the DC voltage supply 216, a failure of one or more PDs 106, an addition of one or more PDs 106, or any other suitable event that has the capability of altering the amount of power outputted by the DC voltage supply 216. The power down signal allows the port controller 410 to rapidly remove power from one or more data ports in the PoE system in response to the alteration in the amount of power available for PoE. The interrupt signal allows the microcontroller 402 to respond to the alteration in the amount of power available for PoE. For example, the microcontroller 402 may apply power to the one or more data ports in the PoE system powered down by the port controller 410, may update the stored power status indicators 350.1 through 350.N using the received power status indicators 350.1 through 350.N, may leave one or more data ports in the PoE system powered down, may generate a system error indicating the alteration in the amount of power available for PoE, or any other suitable event in response to the alternation in the amount of power outputted by the DC voltage supply 216.

The MPSM module 404 or individual components thereof may be readily implemented in hardware, software, or a combination of hardware and software. For example, based on the teachings provided herein, a person skilled in the relevant art could implement the MPSM module 404 via a combination of one or more application specific integrated circuits and a processor core for implementing software commands stored in one or more attached memories. However, this example is not limiting, and other implementations are within the scope and spirit of the present invention.

Referring back to FIG. 4, the microcontroller 402 loads/stores data from the register bank 406 via the shared communication interface 452. The register bank 406 may store and/or load data from the DAC 412, the ADC 414, the MSPM module 404, or any other module connected to the shared communication interface 452. The register bank 406 may be implemented as a processor register, a hardware register, or any other suitable category of storage area for data to be processed by the microcontroller 402. In addition, the register bank 406 may be implemented as, but is not limited to, a general purpose register (GPR) to store both data and addresses, a floating point register (FPR) to store floating point numbers, a constant register to hold read-only values, a vector register to hold data for vector processing done by Single Instruction, Multiple Data (SIMD) instructions, a special function register, or any other suitable class of registers depending on the content of the data to be processed by the microcontroller 402. The register bank 406 may be implemented as a register file, individual flip-flops, high speed core memory, thin film memory, and any other suitable implmentation that will be apparent to those skilled in the art.

The port controller 410 receives the power down signal via the port controller interface 454. In response to the power down signal, the port controller 410 initiates a power down scheme to rapidly remove power from the one or more data ports in the PoE system. In an exemplary embodiment, the port controller 410 rapidly removes power from the one or more data ports in the PoE system in less than one microsecond. The port controller 410 communicates the rapid power down signal to the one or more data ports in the PoE system via a data port controller interface 450. The data port controller interface 450 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The data port controller interface 450 may be implemented as a serial data bus, a parallel data bus, one or more point-to-point connections, one or more point-to-multipoint connections, or any other suitable connection capable of communicating data.

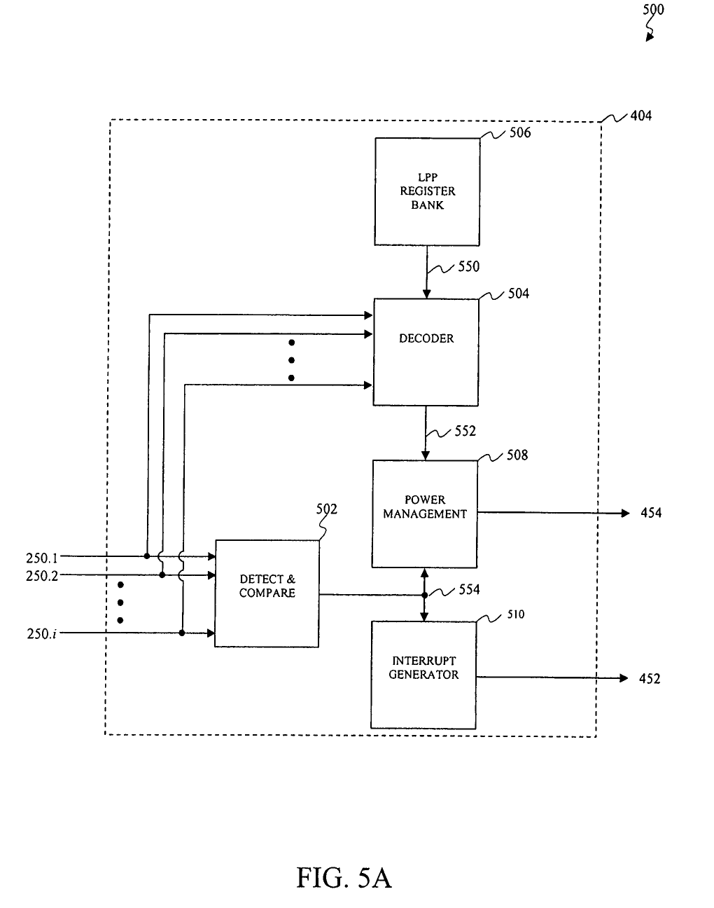

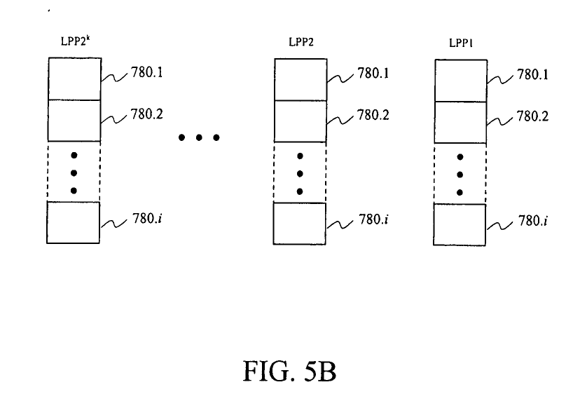

FIG. 5A is an illustration of a block diagram 500 of a multiple power supply management (MPSM) module according to an exemplary embodiment of the present invention. From the discussion above, the MPSM module 404 receives the power status indicators 350.1 through 350.N via the power bank data interface 250. In an exemplary embodiment, the power bank data interface 250 includes the power bank data connections 250.1 through 250.3. Those skilled in the arts will recognize that the power bank data interface 250 may include any number of power bank data connections 250 without departing from the spirit and scope of the invention.

Referring to FIG. 5A, the MPSM module 404 includes a detection/comparison module 502, a decoder 504, a low power priority (LPP) register bank 506, a power management subsystem 508, and an interrupt generator 510. The detection/comparison module 502 receives the power status indicators 350.1 through 350.N via the power bank data connections 250.1 through 250.i to output an indication of alteration in the amount of power available for PoE via a shared communication interface 554. The shared communication interface 554 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The shared communication interface 554 may be implemented as a serial data bus, a parallel data bus, one or more point-to-point connections, one or more point-to-multipoint connections, or any other suitable connection capable of communicating data.

The detection/comparison module 502 compares the values of received power status indicators 350.1 through 350.N with default or stored power status indicators 350.1 through 350.N. The default or stored power status indicators 350.1 through 350.N may be stored in an external memory, such as a ROM or a RAM to provide some examples, stored in a register file, such as register bank 406 to provide an example, loaded from a microcontroller, such as microcontroller 402 to provide an example, loaded into the detection/comparison module 502 via a software program or by firmware implemented in hardware to provide some examples or using any other suitable means capable of storing and/or loading data.

When the value of received power status indicators 350.1 through 350.N substantially differs from the stored power status indicators 350.1 through 350.N, the detection/comparison module 502 generates the indication of alteration in the amount of power available for PoE. The stored power status indicators 350.1 through 350.N may be previously received power status indicators, power status indicators programmed by an external source, or any other suitable prior power status indicator that may be compared to the received power status indicators 350.1 through 350.N. A difference between the stored power status indicators 350.1 through 350.N and the received power status indicators 350.1 through 350.N represents an alteration in an amount of power available for PoE. For example, the amount of power available for PoE may decrease as a result of a failure of one or more DC voltage supplies 302.1 through 302.N to the DC voltage supply 216, an addition of one or more DC voltage supplies 302.1 through 302.N to the DC voltage supply 216, a failure of one or more PDs 106, an addition of one or more PDs 106, or any other suitable event that has the capability of altering the amount of power outputted by the DC voltage supply 216. On the other hand, when the value of received power status indicators 350.1 through 350.N is substantially similar to the stored power status indicators 350.1 through 350.N, the detection/comparison module 502 does not generate the indication of alteration in the amount of power available for PoE, thereby allowing the data ports in the PoE system to remain at their respective state.

After the detection/comparison module 502 compares the values of received power status indicators 350.1 through 350.N with the stored power status indicators 350.1 through 350.N, the detection/comparison module 502 transmits the indication of alteration in the amount of power available for PoE via shared communication interface 554 upon detecting an edge of the indication of alteration in the amount of power available for PoE. The detection/comparison module 502 may transmit the indication of alteration in the amount of power available for PoE upon detecting, but not limited to the rising edge, the falling edge, or any other suitable transition between logic states in the indication of alteration in the amount of power available for PoE.

The decoder 504 receives a response to the alteration in the amount of power available for PoE via a register interface 550. The register interface 550 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The register interface 550 may be implemented as a serial data bus, a parallel data bus, one or more point-to-point connections, one or more point-to-multipoint connections, or any other suitable connection capable of communicating data. The decoder 504 outputs the response to the alteration in the amount of power available for PoE based upon the received power status indicators 350.1 through 350.N via a decoder interface 552. The decoder interface 552 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The decoder interface 552 may be implemented as a serial data bus, a parallel data bus, one or more point-to-point connections, one or more point-to-multipoint connections, or any other suitable connection capable of communicating data.

The decoder outputs a corresponding response to the alteration in the amount of power available for PoE for each data port in the PoE system via the decoder interface 552 based upon the received power status indicators 350.1 through 350.N. For example, in response to a first combination of power status indicators 350.1 through 350.N, the decoder 504 outputs a first response to the alteration in the amount of power available for PoE for each data port in the PoE system. Similarly, in response to a second combination of power status indicators 350.1 through 350.N, the decoder 504 outputs a second response to the alteration in the amount of power available for PoE for each data port in the PoE system. Likewise, in response to an n-th combination of power status indicators 350.1 through 350.N, the decoder 504 outputs an n-th response to the alteration in the amount of power available for PoE for each data port in the PoE system.

The LPP register bank 506 stores and/or loads the responses to the alteration in the amount of power available for PoE for each data port in the PoE system. Those skilled in the art will recognize that the functionality of the LPP register bank 506 may be implemented using other suitable classes of storage media such as a volatile memory, for example a read-only memory (ROM), a non-volatile memory, such as a random access memory (RAM) or any other device capable of storing data without departing from the spirit and scope of the invention.

FIG. 5B is an illustration of a block diagram of a low power priority (LPP) register bank according to an exemplary embodiment of the present invention. The LPP register bank 506 may be implemented as a processor register, a hardware register, or any other suitable category of storage area. In addition, the LPP register bank 506 may be implemented as, but not limited to, a general purpose register (GPR) to store both data and addresses, a floating point register (FPR) to store floating point numbers, a constant register to hold read-only values, a vector register to hold data for vector processing done by Single Instruction, Multiple Data (SIMD) instructions, a special function register, or any other suitable class of registers. The LPP register bank 506 may be implemented as a register file, individual flip-flops, high speed core memory, thin film memory, or by any other suitable implmentation that will be apparent to those skilled in the art. Alternately, the MPSM module 404 may store and/or load the responses of the MPSM module 404 to the alteration in the amount of power available for PoE from any other suitable location such as the register bank 406 to provide an example.

The LPP register bank 506 stores and/or loads the responses to the alteration in the amount of power available for PoE for each data port in the PoE system. In an exemplary embodiment, the responses to the alteration in the amount of power available for PoE for each data port in the PoE system may be, but are not limited to, programmed into the LPP register bank 506 by an external source, such as a software program or a firmware implementation in hardware. More specifically, as shown in FIG. 5B, the LPP register bank 506 includes 2^{k} registers LPP1 through LPP2^{k} to store and/or load 2^{k} responses to the alteration in the amount of power available for PoE for each data port in the PoE system. Each LPP register may be further divided into i slots, denoted as 780.1 through 780.i, corresponding to the number of data ports in the PoE system. For example, an LPP register, such as LPP1, may be divided into four slots for a PoE system having four data ports. Thus, the LPP register bank 506 includes, but is not limited to, 2^{k}*n slots, where n represents the number of data ports in the PoE system and 2^{k} represents the number of responses to the alteration in the amount of power available for PoE for each data port in the PoE system. The data contained within a slot corresponds to a response to the alteration in the amount of power available for PoE for each data port in the PoE system. Those skilled in the arts will recognize that the LPP register bank need not contain 2^{k}*n slots without departing from the spirit and scope of the invention. For example, an LPP register bank may use a single slot to store and/or load data corresponding to one or more data ports in the PoE system or the LPP register bank 506 may use a single LPP register to store and/or load data corresponding to one or more responses to the alteration in the amount of power available for PoE.

Referring back to FIG. 5A, the power management module 508 receives the response to the alteration in the amount of power available for PoE for each data port in the PoE system via the decoder interface 552 and/or the indication of alteration in the amount of power available for PoE via the shared communication interface 554. After receiving the indication of alteration in the amount of power available for PoE via the shared communication interface 554, the power management module 508 generates the power down signal to the port controller 410 via the port controller interface 454. The response to the alteration in the amount of power available for PoE forms the basis of the power down signal to allow the port controller 410 to remove power or to deactivate one or more data ports in the PoE system. In an exemplary embodiment, each response to the alteration in the amount of power available for PoE includes necessary information to power down one or more data ports in the PoE system. Alternatively, each response to the alteration in the amount of power available for PoE includes necessary information to power down each and every data port in the PoE system.

The interrupt generator 510 receives the indication of alteration in the amount of power available for PoE via the shared communication interface 554. The interrupt generator 510 generates the interrupt signal to be transmitted to the microcontroller 402 via the shared communication interface 452 based upon the presence of the indication of alteration in the amount of power available for PoE. The interrupt signal may include, but is not limited to, a hardware interrupt, a software interrupt and/or a combination of a hardware and software interrupt. The interrupt signal may additionally include a level-triggering interrupt, an edge-triggering interrupt, a message-signaling interrupt, and/or any other suitable event triggering interrupt individually or in combination.

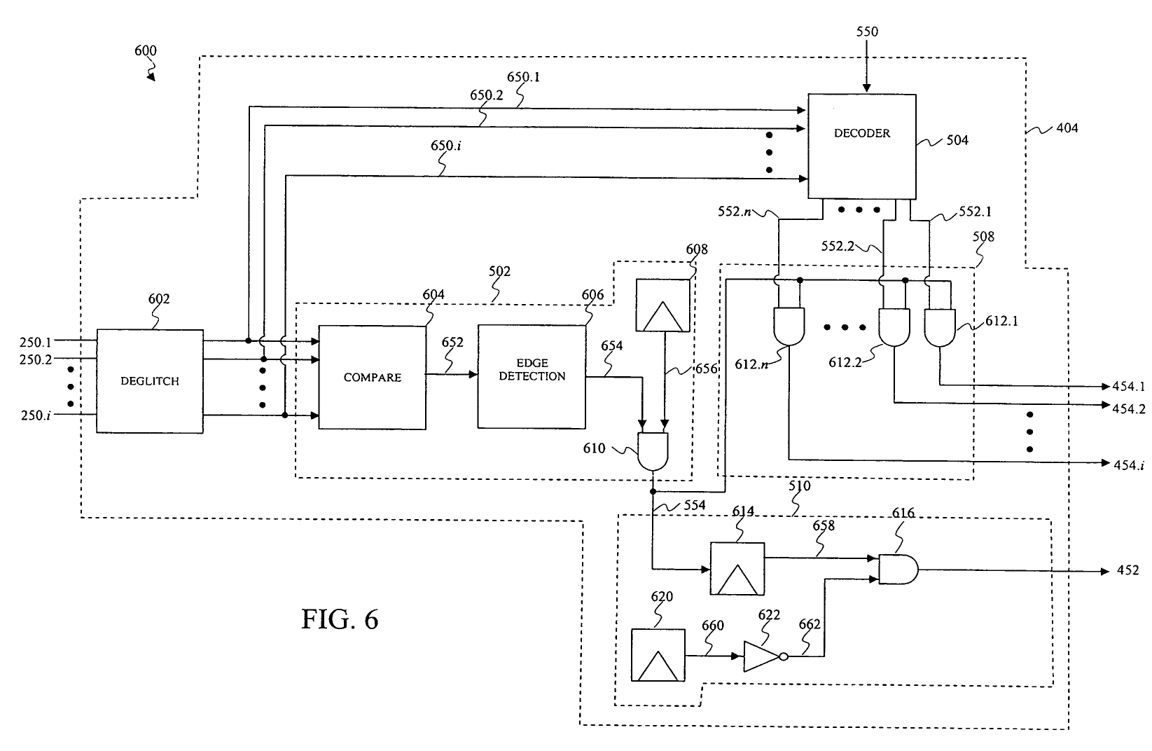

FIG. 6 is an illustration of a block diagram 600 of a multiple power supply management (MPSM) module according to another exemplary embodiment of the present invention. From the discussion above, the MPSM module 404 receives the power status indicators 350.1 through 350.N via the power bank data interface 250. Referring to FIG. 6, the MPSM module 404 includes the detection/comparison module 502, the decoder 504, the low power priority (LPP) register bank 506, the power management subsystem 508, the interrupt generator 510, and a deglitch module 602.

The deglitch module 602 receives the power status indicators 350.1 through 350.N via the power bank data connections 250.1 through 250.i to output a deglitched representation of the received power status indicators 350.1 through 350.N via a shared communication interface 650. The shared communication interface 650 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The shared communication interface 650 may be implemented as a serial data bus, a parallel data bus, one or more point-to-point connections, one or more point-to-multipoint connections, or any other suitable connection capable of communicating data.

The deglitch module 602 removes glitches, if present, from the received power status indicators 350.1 through 350.N to output the deglitched representation of the received power status indicators 350.1 through 350.N via the shared communication interface 650. A glitch is an electrical pulse of short duration. In other words, a glitch occurs when the received power status indicators 350.1 through 350.N are shorter in duration than a specified minimum duration. The deglitch module 602 may use a minimum width threshold or any other suitable means to discriminate between pulse widths to determine the presence and/or absence of glitches in the received power status indicators 350.1 through 350.N. When a glitch is present in the received power status indicators 350.1 through 350.N, the deglitch module 602 blocks or removes the glitch.

The detection/comparison module 502 receives the deglitched representation of the received power status indicators 350.1 through 350.N via the shared communication interface 650 to output the indication of alteration in the amount of power available for PoE via the shared communication interface 554. The detection/comparison module 502 includes a comparison module 604, an edge detection module 606, a register 608, and digital logic 610.

The comparison module 604 receives the deglitched representation of the received power status indicators 350.1 through 350.N via the shared communication interface 650 and outputs the indication of alteration in the amount of power available for PoE via a comparison module interface 652. The comparison module interface 652 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The comparison module interface 652 may be implemented as a serial data bus, a parallel data bus, one or more point-to-point connections, one or more point-to-multipoint connections, or any other suitable connection capable of communicating data. The comparison module 604 compares the values of received power status indicators 350.1 through 350.N with default or stored power status indicators 350.1 through 350.N as previously described in FIG. 5A.

The edge detection module 606 receives the indication of alteration in the amount of power available for PoE via the comparison module interface 652 and outputs the indication of alteration in the amount of power available for PoE via the edge detection interface 654. The edge detection interface 654 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The edge detection interface 654 may be implemented as a serial data bus, a parallel data bus, one or more point-to-point connections, one or more point-to-multipoint connections, or any other suitable connection capable of communicating data. The edge detection module 606 transmits the indication of alteration in the amount of power available for PoE via shared communication interface 554 upon detecting an edge of the indication of alteration in the amount of power available for PoE as previously described in FIG. 5A.

The register 608 provides a disable function of the MPSM module 404 via a register interface 656. The register interface 656 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The register interface 656 may be implemented as a serial data bus, a parallel data bus, one or more point-to-point connections, one or more point-to-multipoint connections, or any other suitable connection capable of communicating data.

Data indicating whether the MPSM module 404 is enabled and/or disabled may be stored in an external memory, such as a ROM or a RAM to provide some examples, stored in a register file, such as register bank 406 to provide an example, loaded from a microcontroller, such as microcontroller 402 to provide an example, loaded into the detection/comparison module 502 via a software program or by firmware implemented in hardware to provide some examples or using any other suitable means capable of storing and/or loading data. Those skilled in the art will recognize that the functionality of the register 608 may be implemented using other suitable classes of storage media such as a volatile memory, for example a read-only memory (ROM), a non-volatile memory, such as a random access memory (RAM) or any other device capable of storing data without departing from the spirit and scope of the invention. The register 608 may be implemented as a processor register, a hardware register, or any other suitable category of storage area. In addition, the register 608 may be implemented as, but not limited to, a general purpose register (GPR) to store both data and addresses, a floating point register (FPR) to store floating point numbers, a constant register to hold read-only values, a vector register to hold data for vector processing done by Single Instruction, Multiple Data (SIMD) instructions, a special function register, or any other suitable class of registers. The register 608 may be implemented as a register file, individual flip-flops, high speed core memory, thin film memory, or by any other suitable implmentation that will be apparent to those skilled in the art.

The digital logic 610 receives the indication of alteration in the amount of power available for PoE via the edge detection interface 654 and outputs the indication of alteration in the amount of power available for PoE via the shared communication interface 554. In an exemplary embodiment, the digital logic 610 is implemented as an AND gate that outputs the indication of alteration in the amount of power available for PoE via the shared communication interface 554 only if a logic one is stored in and/or loaded from the register 608. In this embodiment, when a logic zero is stored in and/or loaded from the register 608, the digital logic 610 does not output the indication of alteration in the amount of power available for PoE, and the MPSM module 404 is in effect disabled. Those skilled in the arts will recognize that the digital logic 610 may be implemented using a suitable combination of digital logic gates without departing from the spirit and scope of the invention.

From the discussion of FIG. 5A, the decoder 504 receives the response to the alteration in the amount of power available for PoE via the register interface 550. The decoder 504 receives the response to the alteration in the amount of power available for PoE from a memory storage device (not shown in FIG. 6), such as, but not limited to, the LPP register bank 506. The decoder 504 outputs the response to the alteration in the amount of power available for PoE based upon the received power status indicators 350.1 through 350.N via the decoder interface 552. Referring back to FIG. 6, the decoder interface 552 includes n decoder interface data connections 552.1 to 552.n. In an exemplary embodiment, the decoder interface 552 includes one data connection for each data port in the PoE system. Those skilled in the arts will recognize that the decoder interface 552 may include any number of suitable decoder interface data connections without departing from the spirit and scope of the invention. For example, one or more data ports in the PoE system may share one or more data connections 552. The decoder outputs a corresponding response to the alteration in the amount of power available for PoE for each data port in the PoE system via the decoder interface 552 based upon the received power status indicators 350.1 through 350.N as previously described in FIG. 5A.

Referring back to FIG. 6, the power management module 508 receives the response to the alteration in the amount of power available for PoE for each data port in the PoE system via the decoder interface 552 and/or the indication of alteration in the amount of power available for PoE via the shared communication interface 554. After receiving the indication of alteration in the amount of power available for PoE via the shared communication interface 554, the power management module 508 generates the power down signal to the port controller 410 via the port controller interface 454. The power management module 508 includes the digital logic 610.

The digital logic 612 receives the response to the alteration in the amount of power available for PoE for each data port in the PoE system via the decoder interface 552 and the indication of alteration in the amount of power available for PoE via the shared communication interface 554 to output the power down signal via the port controller interface 454. The shared communication interface 454 includes i shared communication data connections 454.1 to 454.i. In an exemplary embodiment, the port controller interface 454 includes one data connection for each data port in the PoE system. Those skilled in the arts will recognize that the decoder interface 552 may include any number of suitable decoder interface data connections without departing from the spirit and scope of the invention. In an exemplary embodiment, the digital logic 612 is implemented as one or more AND gates that output the power down signal when the indication of alteration in the amount of power available for PoE is present. Those skilled in the arts will recognize that the digital logic 612 may be implemented using a suitable combination of digital logic gates without departing from the spirit and scope of the invention.

The interrupt generator 510 receives the indication of alteration in the amount of power available for PoE via the shared communication interface 554. The interrupt generator 510 generates the interrupt signal to be transmitted to the microcontroller 402 via the shared communication interface 452 based upon the presence of the indication of alteration in the amount of power available for PoE. The interrupt generator 510 includes a register 614, digital logic 616, a register 620, and digital logic 622.

The register 614 stores the indication of alteration in the amount of power available for PoE received via the shared communication interface 554. The register 614 outputs the indication of alteration in the amount of power available for PoE via a register interface 658. The register interface 658 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The register interface 658 may be implemented as a serial data bus, a parallel data bus, one or more point-to-point connections, one or more point-to-multipoint connections, or any other suitable connection capable of communicating data.

The indication of alteration in the amount of power available for PoE may be stored in an external memory, such as a ROM or a RAM to provide some examples, stored in a register file, such as register bank 406 to provide an example, loaded from a microcontroller, such as microcontroller 402 to provide an example, loaded into the detection/comparison module 502 via a software program or by firmware implemented in hardware to provide some examples or using any other suitable means capable of storing and/or loading data. Those skilled in the art will recognize that the functionality of the register 614 may be implemented using other suitable classes of storage media such as a volatile memory, for example a read-only memory (ROM), a non-volatile memory, such as a random access memory (RAM) or any other device capable of storing data without departing from the spirit and scope of the invention. The register 614 may be implemented as a processor register, a hardware register, or any other suitable category of storage area. In addition, the register 614 may be implemented as, but not limited to, a general purpose register (GPR) to store both data and addresses, a floating point register (FPR) to store floating point numbers, a constant register to hold read-only values, a vector register to hold data for vector processing done by Single Instruction, Multiple Data (SIMD) instructions, a special function register, or any other suitable class of registers. The register 614 may be implemented as a register file, individual flip-flops, high speed core memory, thin film memory, or by any other suitable implmentation that will be apparent to those skilled in the art.

The register 608 provides a disable function of the interrupt generator 510 via a register interface 660. The register interface 660 is implemented according to known communications standards such as, but not limited to, Inter-Integrated Circuit (I²C) Bus, PCI Express (PCIe), Serial Peripheral Interface (SPI) Bus, Universal Serial Bus (USB), or any other suitable communication protocol to provide some examples. The register interface 660may be implemented as a serial data bus, a parallel data bus, one or more point-to-point connections, one or more point-to-multipoint connections, or any other suitable connection capable of communicating data.

The data indicating whether the interrupt generator 510 is enabled and/or disabled may be stored in an external memory, such as a ROM or a RAM to provide some examples, stored in a register file, such as register bank 406 to provide an example, loaded from a microcontroller, such as microcontroller 402 to provide an example, loaded into the detection/comparison module 502 via a software program or by firmware implemented in hardware to provide some examples or using any other suitable means capable of storing and/or loading data. Those skilled in the art will recognize that the functionality of the register 620 may be implemented using other suitable classes of storage media such as a volatile memory, for example a read-only memory (ROM), a non-volatile memory, such as a random access memory (RAM) or any other device capable of storing data without departing from the spirit and scope of the invention. The register 620 may be implemented as a processor register, a hardware register, or any other suitable category of storage area. In addition, the register 620 may be implemented as, but not limited to, a general purpose register (GPR) to store both data and addresses, a floating point register (FPR) to store floating point numbers, a constant register to hold read-only values, a vector register to hold data for vector processing done by Single Instruction, Multiple Data (SIMD) instructions, a special function register, or any other suitable class of registers. The register 620 may be implemented as a register file, individual flip-flops, high speed core memory, thin film memory, or by any other suitable implmentation that will be apparent to those skilled in the art.

The digital logic 622 receives the disable function of the interrupt generator 510 via the register interface 660 to output a formatted disable function of the interrupt generator 510 via digital logic interface 662. The digital logic interface 662 is implemented according to known communications standards such as, but not limited to, Inter-Integrated Circuit (1²C) Bus, PCI Express (PCIe), Serial Peripheral Interface (SPI) Bus, Universal Serial Bus (USB), or any other suitable communication protocol to provide some examples. The digital logic interface 662 may be implemented as a serial data bus, a parallel data bus, one or more point-to-point connections, one or more point-to-multipoint connections, or any other suitable connection capable of communicating data. In an exemplary embodiment, the digital logic 622 is implemented as an inverter that inverts the disable function of the interrupt generator 510 to output the formatted disable function of the interrupt generator 510 via the digital logic interface 662. Those skilled in the arts will recognize that the digital logic 622 may be implemented using a suitable combination of digital logic gates without departing from the spirit and scope of the invention.

The digital logic 616 receives the indication of alteration in the amount of power available for PoE via the register interface 658 and/or the formatted disable function of the interrupt generator 510 via the digital logic interface 662 to output the interrupt signal via the shared communication interface 452. In an exemplary embodiment, the digital logic 616 is implemented as an AND gate that generates the interrupt signal via the shared communication interface 452 only if a logic one is stored in and/or loaded via the digital logic interface 662. In this embodiment, when a logic zero is stored in and/or loaded from the digital logic interface 662, the digital logic 616 does not output the interrupt signal via the shared communication interface 452. Those skilled in the arts will recognize that the digital logic 616 may be implemented using a suitable combination of digital logic gates without departing from the spirit and scope of the invention.

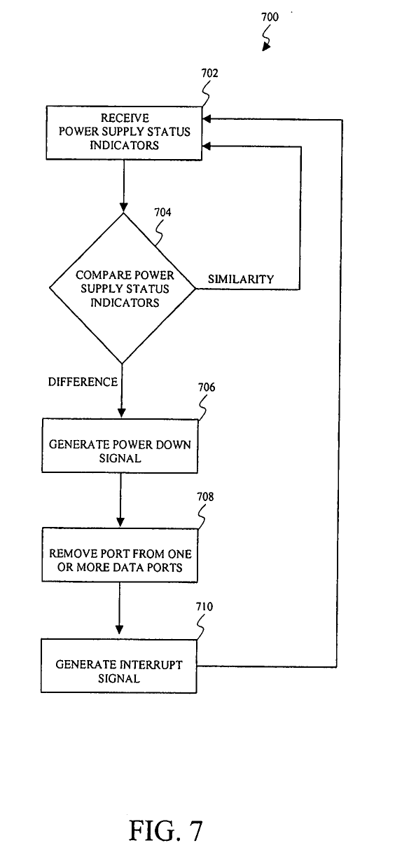

FIG. 7 is a flowchart of exemplary operational steps of a multiple power supply management (MPSM) module according to another exemplary embodiment of the present invention. The MPSM module, such as the MPSM module 404 as shown in FIG. 4, may be readily implemented in hardware, software, or a combination of hardware and software using the teachings herein. For example, based on the teachings provided herein, a person skilled in the relevant art could implement the MPSM module via a combination of one or more application specific integrated circuits and a processor core for implementing software commands stored in one or more attached memories. However, this example is not limiting, and other implementations are within the scope and spirit of the present invention. The invention is not limited to this operational description. Rather, it will be apparent to persons skilled in the relevant art(s) from the teachings herein that other operational control flows are within the scope and spirit of the present invention. The following discussion describes the steps in FIG. 7.

At step 702, power status indicators, such as the power status indicators 350.1 through 350.N, are received by the MPSM module via a power bank data interface, such as the power bank data interface 250. The power status indicators are generated by a DC voltage supply, such as the DC voltage supply 216, to indicate, but are not limited to, the total amount of the power available for PoE, the amount of the power that is currently used for PoE, the amount of the power that is remaining to be used for PoE, or any other suitable indication of the power status related to the DC power to provide some examples.

At step 704, the values of the power status indicators received in step 702 are compared with default or stored power status indicators. When the value of received power status indicators is substantially similar to the stored power status indicators the operational control reverts to step 702. Else, the operational control proceeds to step 706 when the value of received power status indicators is substantially different from the stored power status indicators. A difference between the stored power status indicators and the received power status indicators represents an alteration in an amount of power available for PoE.

At step 706, a power down signal is generated. The power down signal allows the MPSM module to rapidly power remove power from one or more data ports in the PoE system in response to the alteration in the amount of power available for PoE.

At step 708, power is removed from the one or more data ports in the PoE system. In response to the power down signal, a port controller, such as the port controller 410 initiates a power down scheme to rapidly remove power from the one or more data ports in the PoE system. In other words, the MPSM module ceases to provide PoE to the one or more data ports in the PoE system. The port controller communicates the rapid power down signal to the one or more data ports in the PoE system via a data port controller interface, such as the data port controller interface 450.

At step 710, an interrupt signal is generated. The interrupt allows a microprocessor and/or a microcontroller, such as the microcontroller 402 to respond to the alteration in the amount of power available for PoE. For example, the microprocessor and/or the microcontroller may apply power to the one or more data ports in the PoE system powered down by the port controller, may update the stored power status indicators using the received power status indicators from step 702, may leave one or more data ports in the PoE system powered down, may generate a system error indicating the alteration in the amount of power available for PoE, or any other suitable event in response to the alternation in the amount of power outputted by the DC voltage supply.

After step 710, the operational control reverts back to step 702 to receive and process another set of power status indicators.

### CONCLUSION

While various embodiments of the present invention have been described above, it should be understood that they have been presented by way of example, and not limitation. It will be apparent to persons skilled in the relevant arts that various changes in form and detail can be made therein without departing from the spirit and scope of the invention. Thus the present invention should not be limited by any of the above-described exemplary embodiments, but should be defined only in accordance with the following claims and their equivalents.

What is claimed is:

1. A multiple power supply management (MPSM) apparatus for a Power-over-Ethernet (PoE) system comprising:
a detection/comparison module configured to receive one or more power status indicators, wherein the detection/comparison module compares the received one or more power status indicators with a stored one or more power status indicators and outputs an indication of alteration in an amount of power available for PoE when the received one or more power status indicators substantially differ from the stored one or more power status indicators;
a low power priority (LPP) register bank to store one or more responses to the indication of alteration in the amount of power available for PoE;
a decoder to output one or more responses from the stored one or more responses to the indication of alteration in the amount of power available for PoE based upon the received one or more power status indicators;
a power management subsystem to generate a power down signal based upon the one or more responses when the indication of alteration in an amount of power available for PoE is present; and
an interrupt generator to generate an interrupt signal when the indication of alteration in an amount of power available for PoE is present.

2. The MPSM apparatus of claim 1, further comprising:
a DC voltage supply to generate the received one or more power status indicators.

3. The MPSM apparatus of claim 2, wherein the DC voltage supply further comprises:
one or more DC voltage supplies, wherein each of the one or more DC voltage supplies generates a power status indicator.

4. The MPSM apparatus of claim 3, wherein the one or more DC voltage supplies includes at least one of:
an AC/DC power supply; or
a DC/DC power supply.

5. The MPSM apparatus of claim 1, wherein the detection/comparison module receives the one or more power status indicators via a power bank interface.

6. The MPSM apparatus of claim 1, wherein the detection/comparison module outputs the indication of alteration in an amount of power available for PoE upon detecting an edge of the indication of alteration in an amount of power available for PoE.

7. The MPSM apparatus of claim 6, wherein the edge of the indication of alteration in an amount of power available for PoE includes at least one of:
a falling edge; or
a rising edge.

8. The MPSM apparatus of claim 1, wherein the LPP register bank further comprises:
one or more registers to store the one or more responses to the indication of alteration in the amount of power available for PoE.

9. The MPSM apparatus of claim 8, wherein each of the one or more registers includes one or more slots.

10. The MPSM apparatus of claim 1, wherein the power management subsystem is used to power down one or more data ports in the PoE system.

11. The MPSM apparatus of claim 1, wherein the interrupt signal causes a microcontroller to perform at least one of the following:
apply power to one or more data ports in the PoE system powered down by a port controller;
update the stored power status indicators using the received power status indicators;
leave the one or more data ports in the PoE system powered down; or
generate a system error.

12. A Power Source Equipment (PSE) controller for a Power-over-Ethernet (PoE) system comprising:
a multiple power supply management (MPSM) module for a Power-over-Ethernet (PoE) system, wherein the MPSM module includes:
a detection/comparison module configured to receive one or more power status indicators, wherein the detection/comparison module compares the received one or more power status indicators with a stored one or more power status indicators and outputs an indication of alteration in an amount of power available for PoE when the received one or more power status indicators substantially differ from the stored one or more power status indicators;
a low power priority (LPP) register bank to store one or more responses to the indication of alteration in the amount of power available for PoE;
a decoder to output one or more responses from the stored one or more responses to the indication of alteration in the amount of power available for PoE based upon the received one or more power status indicators;
a power management subsystem to generate a power down signal based upon the one or more responses when the indication of alteration in an amount of power available for PoE is present; and
an interrupt generator to generate an interrupt signal when the indication of alteration in an amount of power available for PoE is present;
a microcontroller configured to receive the interrupt signal;
a register bank coupled to the microcontroller; and
a port controller configured to power down one or more data ports in the PoE system based upon the power down signal.

13. The PSE controller of claim 12, further comprising:
a DC voltage supply to generate the received one or more power status indicators.

14. The PSE controller of claim 13, wherein the DC voltage supply further comprises:
one or more DC voltage supplies, wherein each of the one or more DC voltage supplies generates a power status indicator.

15. The PSE controller of claim 14, wherein the one or more DC voltage supplies includes at least one of:
an AC/DC power supply; or
a DC/DC power supply.

16. The PSE controller of claim 12, wherein the detection/comparison module receives the one or more power status indicators via a power bank interface.

17. The PSE controller of claim 12, wherein the detection/comparison module outputs the indication of alteration in an amount of power available for PoE upon detecting an edge of the indication of alteration in an amount of power available for PoE.

18. The PSE controller of claim 17, wherein the edge of the indication of alteration in an amount of power available for PoE includes at least one of:
a falling edge; or
a rising edge.

19. The PSE controller of claim 12, wherein the LPP register bank further comprises:
one or more registers to store the one or more responses to the indication of alteration in the amount of power available for PoE.

20. The PSE controller of claim 19, wherein each of the one or more registers includes one or more slots.

21. The MPSM apparatus of claim 12, wherein the interrupt signal causes the microcontroller to perform at least one of the following:
apply power to one or more data ports in the PoE system powered down by a port controller;
update the stored power status indicators using the received power status indicators;
leave the one or more data ports in the PoE system powered down; or
generate a system error.

22. A method to manage multiple power supplies in a Power-over-Ethernet (PoE) system comprising:
receiving one or more power status indicators;
comparing the received one or more power status indicators with a stored one or more power status indicators;
generating an indication of alteration in an amount of power available for PoE when the one or more power status indicators substantially differ from the stored one or more power status indicators;
generating one or more responses from a stored one or more responses to the indication of alteration in the amount of power available for PoE based upon the received one or more power status indicators;
generating a power down signal based upon the stored one or more responses to the indication of alteration in the amount of power available for PoE when the indication of alteration in an amount of power available for PoE is present; and
generating an interrupt signal when the indication of alteration in an amount of power available for PoE is present.
